(19) United States
(12) Patent Application Publication
(10) Pub. No.: US 2004/0239584 A1
(43) Pub. Date: Dec. 2, 2004

(54) Image display device

(76) Inventors: Martin Edelmann, Aalen (DE); Bernd Spruck, Mogglingen (DE); Markus Seesselberg, Aalen (DE); Bertram Achtner, Schwabisch Gmund (DE); Frank Holler, Aalen (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/799,259

(22) Filed: Mar. 12, 2004

(30) Foreign Application Priority Data
Mar. 14, 2003 (DE) 103 11 306.1

(51) Int. Cl. G09G 5/00

(52) U.S. Cl. 345/8

(57) ABSTRACT

An image display device is provided, comprising imaging optics having an exit pupil, said imaging optics generating a projection of an image perceivable by an observer, and comprising pupil optics, said pupil optics spatially multiplying the exit pupil of the imaging optics and/or moving the exit pupil.

This application claims priority to German Application No. 10311306.1 filed Mar. 14, 2003. Said application is incorporated by reference herein.

### BACKGROUND OF THE INVENTION

The invention relates to an image display device comprising imaging optics having an exit pupil, said imaging optics generating a projection of an image perceivable by an observer.

Such an image display device is, for example, a so-called HMD device (Head Mounted Display device), wherein an observer wears the image display device on his head. In designing an HMD device, a large exit pupil is desirable for insensitive adjustment and to allow for the eye movement of the observer, because, as a result of this, at least part of the light is always incident over a large lateral area into the eye of the observer. Although a smaller exit pupil leads to a significant simplification of the optical design, it is disadvantageous because adjustment is more complicated and because the area of the movement of the observer's eye in which he can still perceive the image is smaller.

In view thereof, it is an object of the present invention to provide an image display device wherein the structure of the imaging optics may be simplified and the observer can always perceive the image, in a manner as independent as possible of the position of his eyes.

### SUMMARY OF THE INVENTION

According to the invention, this object is achieved by an image display device comprising imaging optics having an exit pupil, said imaging optics generating a projection of an image perceivable by a observer, and comprising pupil optics, said pupil optics spatially multiplying the exit pupil of the imaging optics and/or moving the exit pupil.

As a result of said spatial multiplication of the exit pupil and/or by the movement of the exit pupil, the observer can always perceive the image, although the exit pupil may have a small size. In particular, the exit pupil may be only slightly larger or even smaller than the pupil of the observer's eye. The small exit pupil of the imaging optics leads to the advantage that the optical design of the imaging optics is simplified and that, further, the volume and weight of the imaging optics may be reduced. Further, an improved imaging quality may be achieved if the exit pupil can be selected to have a small size.

In a preferred embodiment of the image display device according to the invention, the pupil optics are arranged following the last beam-forming surface of the imaging optics. This ensures that the imaging optics may be made small. It is only at the very end, i.e. between the imaging optics and the observer's eye, that the spatial multiplication and/or the movement of the exit pupil is generated, so that larger optical elements are required only in this area. In contrast thereto, the imaging optics themselves may be optimized for the small exit pupil, which leads to the reduced volume and the reduced weight of the imaging optics.

In particular, the pupil optics may move or multiply the exit pupil in a plane extending transversely to the optical axis of the imaging optics. This allows a larger area to be covered by the exit pupil, so that the eye movement of the observer may be compensated for.

An advantageous embodiment of the image display device according to the invention consists in that the exit pupil is moved by means of the pupil optics such that the exit pupil tracks a movement of the pupil of an observer's eye. This has the advantageous effect that nearly the entire light is perceivable by the observer and, thus, no loss in brightness occurs, because the exit pupil always overlies the eye pupil due to said tracking.

In particular, the image display device may comprise an eye-position sensing unit and a control unit, which eye-position sensing unit senses (preferably continuously) the position of the eye and emits signals representing the sensed position, and the control unit controls the pupil optics as a function of said signals such that the exit pupil always tracks the movement of the observer's eye pupil. Thus, a closed loop is provided by which said tracking may be very well effected.

The pupil optics preferably include at least one actuator unit, such as, for example, one or more deflecting galvanometer mirrors. Thus, particularly good and easy tracking is realizable, with very good tracking being possible already with two mirrors.

Further, in the image display device according to the invention, the pupil optics for spatial multiplication of the exit pupil may contain at least one diffractive element, which is preferably provided as a transmissive element. It may be, for example, a diffraction grating, in particular a transmission grating. In this connection, the different orders of diffraction form the spatially multiplied exit pupils. If two diffractive elements (for example, two transmission gratings) are sequentially arranged, the first grating may be employed for splitting into the orders of diffraction, while the second grating serves to parallel the individual orders. This has the advantageous effect that the respective optical rays associated with the individual, spatially multiplied exit pupils are parallel to one another, so that no double images are perceivable. This would be the case if the individual rays were not parallelly offset, but tilted relative to each other. Furthermore, the use of two gratings allows the diffraction efficiency to be kept constant over the entire spectral range.

Further, in the image display device according to the invention, the pupil optics for spatial multiplication of the exit pupil may comprise at least one birefringent element. It is also possible to sequentially arrange several birefringent elements. The number of exit pupils may be doubled for each birefringent element. When using birefringent elements, it is particularly advantageous that they can be easily oriented such that the ordinary ray and the extraordinary ray are offset in parallel relative to each other.

It is further possible to rotate the diffractive element and/or the birefringent element so as to move the exit pupil, said rotation preferably being effected about the optical axis of the imaging optics. Thus, a larger area is covered by the spatially multiplied exit pupils, so that even large movements of the observer's eye will not cause him to no longer see an image. In particular, it is also possible to select the size of the exit pupil of the imaging optics to be smaller than the size of the pupil of the observer's eye, because a larger (overall) area may be covered due to said spatial multiplication and said movement.

Also, in the image display device according to the invention, the pupil optics for moving the exit pupil may contain a rotating, beam-offsetting element, such as, for example, one or more inclined plane-parallel plate(s). This optical element enables a particularly easy realization of the movement of the exit pupil.

In a preferred embodiment of the image display device according to the invention, the pupil optics cause a spatial multiplication of the exit pupil in such a manner that the corresponding rays from the individual exit pupils are parallel to one another. This has the advantageous effect that the observer will not see double images, as would be the case when tilting the individual rays relative to one another.

Further, in the image display device according to the invention, the pupil optics may effect a spatial multiplication of the exit pupil such that the individual exit pupils cover a continuous area. This is particularly advantageous in order to ensure that the observer can always perceive the image.

In particular, the pupil optics may be provided such that the spatial multiplication and/or the movement of the exit pupil results in a uniform brightness distribution per surface area (time-averaged). Thus, for example, in a pupil offset by the full diameter, the offset pupil is connected with the pupil which has not been offset. In this regard, the retention time may be controlled so as to result in homogeneous brightness conditions for the observer within the new, enlarged pupil.

For example, the pupil optics may comprise one or more deflecting mirrors which multiply and/or move the exit pupil by reproducing the new, larger virtual exit pupil using a scanning pattern. This may be effected, for example, by a helical scan (or deflection) or by a cell or line scan.

The deflecting mirrors may comprise a piezo drive or be provided as galvanometer mirrors and/or as electrostatically deflectable mirrors.

The image display device according to the invention is particularly advantageous in those cases where it serves for personal use together with the observer's eye, as is the case, for example, with HMD devices, microscopes, binoculars and telescopes.

In particular, the image display device may be provided as an HMD device, a microscope, binoculars or as a telescope. If it is provided as an HMD device, it will also contain, in particular, a (preferably electrically) controllable image-generating module. Said image-generating module may be a luminous display, such as a transmissive or reflective LCD or an LED or, for example, a non-luminous display. In particular, the image-generating module may be provided as a so-called (spatial) light valve, for example a tilting mirror matrix comprising a plurality of tilting mirrors arranged in lines and columns and individually controllable, such as that manufactured and delivered by Texas Instruments.

The HMD device may be provided such that the observer only sees the generated and projected image or that he perceives the generated and imaged image as superimposed on the environment (so-called augmented reality).

### DESCRIPTION OF THE FIGURES

The invention is explained in more detail below, essentially by way of example, with reference to the drawings, wherein:

FIG. 1 shows a schematic view of an embodiment of the image display device according to the invention;

FIG. 2 schematically shows the position of the exit pupils of the imaging optics of FIG. 1 in the pupil plane;

FIG. 3 schematically shows the position of the exit pupils in a further embodiment;

FIG. 4 schematically shows the position of the exit pupils according to a further embodiment of the image display device according to the invention;

FIG. 5 shows a schematic view of a further embodiment of the image display device according to the invention;

FIG. 6 schematically shows the position of the exit pupil in the pupil plane of the image display device of FIG. 5, and

FIG. 7 schematically shows a further embodiment of the image display device according to the invention.

### DETAILED DESCRIPTION OF THE PREFERRED EMBODIMENTS

In one embodiment, as best shown in FIG. 1, the image display device according to the invention comprises an image-generating module 1 (e.g. a transmissive or reflective LCD module) which is controllable by means of a control unit 2 for image generation. Furthermore, imaging optics 3 are provided (in FIG. 1, only one lens is schematically indicated, although the imaging optics 3 usually comprise several optical elements, which may have a refractive, reflective and/or diffractive effect), which effect imaging of the image generated by the image-generating module 1 such that an observer (represented by the schematically indicated eye A) will see the image at infinity. In other words, the light rays coming from one pixel (indicated for the pixel P in FIG. 1) pass through the exit pupil 4 of the imaging optics 3 as a parallel bundle of rays.

The image display device further comprises pupil optics 5 embodied by a birefringent element (e.g. of calcite or quartz) in the example shown in FIG. 1. The birefringent element 5 is arranged between the eye A of the observer and the imaging optics 3 and is, therefore, arranged following the last beam-forming surface F of the imaging optics 3. The orientation of the birefringent element 5 is selected such that the light rays 61, 62 coming from one pixel are respectively split into the ordinary rays 61A, 62A and, parallelly offset thereto, the extraordinary rays 61B, 62B, as schematically indicated for the pixel P of the image to be imaged in FIG. 1.

Now, said parallel offset causes the imaging optics 3 to comprise a spatially offset, further exit pupil 8 in addition to its original exit pupil 4. The spatially offset exit pupil 8 is indicated adjacent to the original exit pupil 4 only for the sake of a better representation. In fact, both exit pupils 4 and 8 are located in the same plane E which extends perpendicular to the optical axis OA of the imaging optics 3.

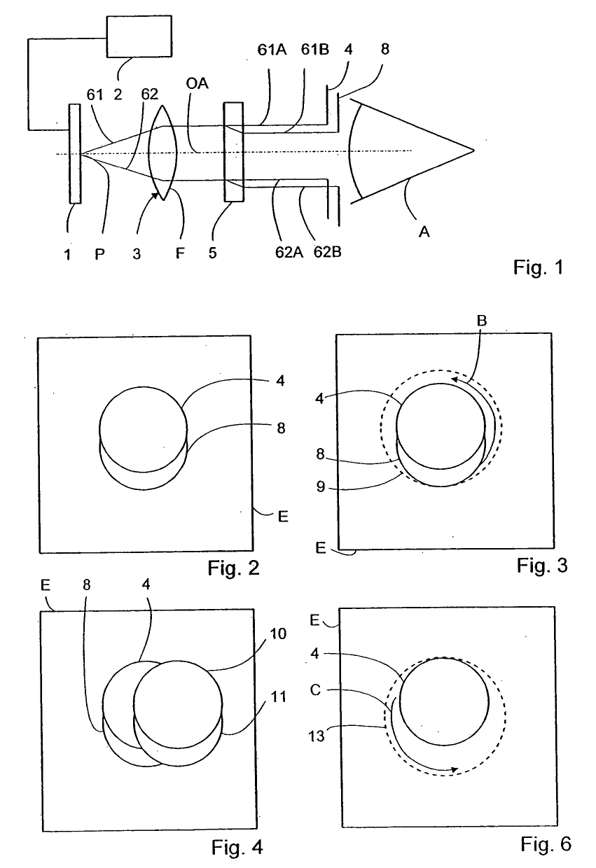

FIG. 2 shows the position of both exit pupils 4 and 8 in the plane E. As is evident from this representation, the exit pupil perceivable by the observer is larger than the individual exit pupils 4 and 8, so that the imaging optics 3 may be advantageously adapted to the small exit pupil 4, so that the optical design is simplified and the weight and volume of the imaging optics 3 can be reduced. However, for the observer, the image display device comprises a larger exit pupil, namely the combination of both exit pupils 4 and 8.

A further enlargement of the exit pupil perceivable by the observer may be achieved by rotating the birefringent element 5 about the optical axis OA of the imaging optics 3. As indicated by the arrow B in FIG. 3, this has the effect that the second exit pupil 8 performs a circular movement within the plane and, in doing so, partially orbits around the first exit pupil 4. If the rotation of the birefringent element 5 is carried out sufficiently fast, so that the observer can no longer perceive the thus caused movement of the exit pupil 8, a clearly larger apparent exit pupil 9 is generated.

In order to effect the rotation of the birefringent element 5, the latter may be retained, for example, in a rotatable fitting (not shown), said fitting being driven in rotation so as to rotate the birefringent element 5. This may be carried out under the control of the control unit 2.

In a further design of the embodiment of FIG. 1, a further birefringent element (not shown) may be arranged following the birefringent element 5 such that the imaging optics 3 comprise a total of four exit pupils 4, 8, 10, 11, as shown in FIG. 4.

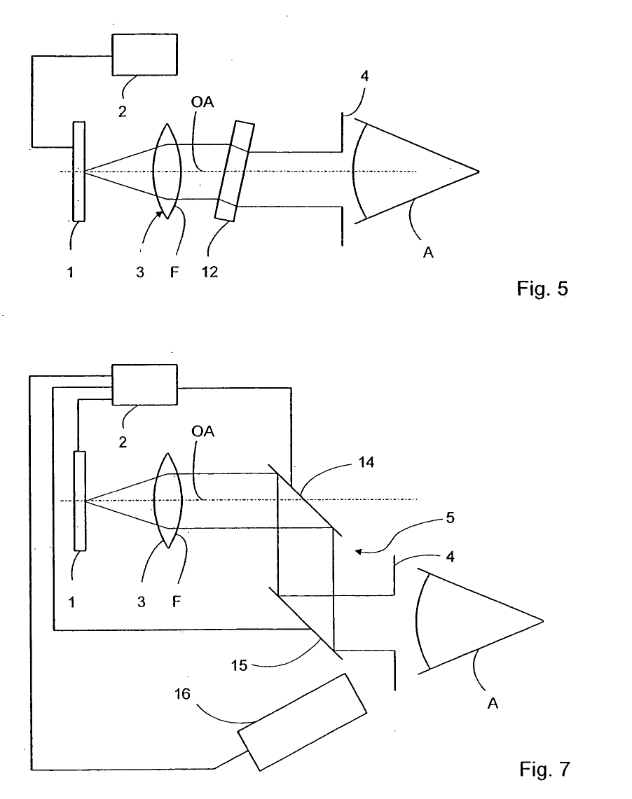

FIG. 5 shows a further embodiment of the image display device, wherein the embodiment of FIG. 5 differs from that of FIG. 1 only in that a plane-parallel plate 12, which is rotatable about the optical axis OA and is inclined relative thereto, is provided instead of the birefringent element 5. The plane-parallel plate 12, which is inclined relative to the optical axis OA at an angle not equal to 90°, causes a beam offset as schematically indicated in FIG. 5. The rotation of the plane-parallel plate 12 leads to a circular movement of the exit pupil 4 within the pupil plane E (indicated by arrow C in FIG. 6). If the rotation of the plane-parallel plate 12 is effected sufficiently fast, the observer will no longer perceive the movement of the exit pupil 4. Thus, the observer is given the illusion of a virtually larger exit pupil 13.

FIG. 7 shows a further embodiment of the image display device according to the invention, which, in a similar manner as the embodiment of FIG. 1, comprises an image-generating module 1 controlled by a control unit 2 to generate images, imaging optics 3 as well as pupil optics 5. In contrast to the previous embodiments, the pupil optics 5 comprise two deflecting galvanometer mirrors 14, 15 whose mirror surfaces are parallel to each other and whose rotary position is set by means of the control unit 2.

Further, the image display device comprises a sensor unit 16, which continously senses the position of the pupil of the observer's eye A. Such a sensor unit 16 may be provided, for example, in the manner of a so-called eye tracker in an HMD device.

The sensor unit 16 continuously senses the position of the eye pupil of the observer's eye A and transmits corresponding signals to the control unit 2, which controls the deflecting galvanometer mirrors 14 and 15 as a function of the signals received from the sensor unit 16, such that the exit pupil 4 of the imaging optics 3 tracks the eye pupil of the observer's eye A. Thus, the exit pupil 4 of the imaging optics 3 moves along with the eye pupil. The image display device thus comprises a closed loop which constantly makes the exit pupil 4 of the imaging optics 3 track the pupil position of the eye A. Since the pupil optics 5 are arranged following the last beam-forming surface F of the imaging optics 3, the pupil optics 5, while influencing the pupil position of the exit pupil 4, do not influence the position of the image to be generated by the image-generating module 1.

A particular advantage of this embodiment consists in that hardly any loss in brightness occurs, because the exit pupil 4 of the imaging optics 3 needs to be selected only slightly larger than the pupil of the eye A and, therefore, nearly the entire light of the projected image is perceived by the observer.

In the described embodiments, the exit pupil(s) 4, 8, 10 and 11 of the imaging optics 3 preferably lie(s) in or near the eye pupil of the observer's eye A, if he uses the image display device according to its intended purpose.

Although the description above contains many specificities, these should not be construed as limiting the scope of the invention but as merely providing illustrations of some of the presently preferred embodiments of the invention. Thus, the scope of the invention should be determined by the appended claims and their legal equivalents, rather than by the examples given.

1. An image display device comprising imaging optics having an exit pupil, said imaging optics generating a projection of an image perceivable by an observer, and comprising pupil optics, said pupil optics spatially multiplying the exit pupil of the imaging optics, moving the exit pupil or a combination of the foregoing.

2. The image display device as claimed in claim 1, wherein the pupil optics are arranged following the last beam-forming surface of the imaging optics.

3. The image display device as claimed in claim 1, wherein the pupil optics move the exit pupil in a plane extending transversely to the optical axis of the imaging optics.

4. The image display device as claimed in claim 1, wherein the exit pupil is moved such that it tracks a movement of a pupil of an eye of the observer.

5. The image display device as claimed in claim 1, comprising an eye-position sensing unit and a control unit, said eye-position sensing unit sensing the position of an eye of the observer and emitting signals which represent the sensed position, and said control unit controlling the pupil optics as a function of said signals in order to make the exit pupil track the movement of the eye pupil of the observer.

6. The image display device as claimed in claim 1, wherein the pupil optics comprise at least one actuator unit.

7. The image display device as claimed in claim 6, wherein the actuator unit comprises a galvanometer mirror.

8. The image display device as claimed in claim 1, wherein the pupil optics for spatial multiplication of the exit pupil contain at least one diffractive element.

9. The image display device as claimed in claim 8, wherein the diffractive element comprises a transmissive element.

10. The image display device as claimed in claim 1, wherein the pupil optics for spatial multiplication of the exit pupil comprise at least one birefringent element.

11. The image display device as claimed in claim 8, wherein the element for moving the exit pupil is moved.

12. The image display device as claimed in claim 8, wherein the element for moving the exit pupil is rotated about the optical axis of the imaging optics.

13. The image display device as claimed in claim 10, wherein the element for moving the exit pupil is moved.

14. The image display device as claimed in claim 10, wherein the element for moving the exit pupil is rotated about the optical axis of the imaging optics.

15. The image display device as claimed in claim 1, wherein the pupil optics for moving the exit pupil comprise a rotating, beam-offsetting element.

16. The image display device as claimed in claim 1, wherein the pupil optics cause a spatial multiplication of the exit pupil such that the corresponding rays from the individual exit pupils are parallel to one another.

17. The image display device as claimed in claim 1, wherein the pupil optics cause a spatial multiplication of the exit pupil such that the individual exit pupils cover a continuous area.

18. The image display device as claimed in claim 1, further comprising a head mounted display device and a controllable image-generating module.
